(19) United States
(12) Patent Application Publication
(10) Pub. No.: US 2024/0256961 A1
(43) Pub. Date: Aug. 1, 2024

(54) Method for Generating a Training Dataset, Method for Training an Artificial Intelligence Means, Artificial Intelligence Means, and Hand-Held Power Tool

(71) Applicant: Robert Bosch GmbH, Stuttgart (DE)

(72) Inventors: Andreas Frischen, Leonberg (DE); Bernhard Hegemann, Filderstadt (DE); Dimetric Armand Tadah Teguetio, Stuttgart-Stammheim (DE); Jan Doepner, Heidelberg (DE); Jan Linus Steuler, Woelfersheim (DE); Lars Beseke, Stuttgart (DE); Manuel Peter, Schweigen-Rechtenbach (DE); Uwe Troeltzsch, Roesrath (DE)

(21) Appl. No.: 18/419,827

(22) Filed: Jan. 23, 2024

(30) Foreign Application Priority Data
Jan. 26, 2023 (DE) 10 2023 200 602.2

(51) Int. Cl. G06N 20/00; B25F 5/00

(52) U.S. Cl. CPC G06N 20/00; B25F 5/001

(57) ABSTRACT

A method is for generating a training dataset for training an artificial intelligence system in order to ascertain an operating state and/or to predict an event timepoint of a hand-held power tool. The method includes providing a plurality of measured values of an operating variable of a hand-held power tool, and identifying an event timepoint within the plurality of measured values. The method also includes arranging a plurality of labeled measured values in a time series based on timestamps of the measured values, and providing a training dataset including the time series of labeled measured values of the operating variable.

This application claims priority under 35 U.S.C. § 119 to patent application no. DE 10 2023 200 602.2, filed on Jan. 26, 2023 in Germany, the disclosure of which is incorporated herein by reference in its entirety.

The disclosure relates to a method for generating a training dataset for training an artificial intelligence means. The disclosure also relates to a method for training an artificial intelligence means. The disclosure also relates to an artificial intelligence means for a control system of a hand-held power tool, which is configured to recognize operating states of the hand-held power tool and/or to predict event timepoints in which a transition between different operating states takes place. The disclosure also relates to a hand-held power tool.

### BACKGROUND

Methods for generating training datasets for training artificial intelligence means are known from the prior art.

### SUMMARY

The object of the disclosure is to provide an improved method for generating a training dataset, a method for training an artificial intelligence means, an artificial intelligence means, and a hand-held power tool.

Said object is achieved by means of the method for generating a training dataset, the method for training an artificial intelligence means, the artificial intelligence means and the hand-held power tool as disclosed herein.

A method of controlling a hand-held power tool is provided, comprising:
receiving sensor data of at least one operating variable of the hand-held power tool;
receiving an input value for a control parameter of the hand-held power tool based on a user input from a user of the hand-held power tool;
ascertaining a first target value of the control parameter based on the sensor data and the input value;
executing a state determination module and applying the state determination module to the sensor data and ascertaining an operating state of the hand-held power tool; and
control of the hand-held power tool based on the first target value of the control parameter and the ascertained operating state.

Achieved thereby is the technical advantage that an improved method for controlling a hand-held power tool can be provided, in which, in addition to a user input from a user of the hand-held power tool, an operating state ascertained during operation of the hand-held power tool is also taken into account when controlling the hand-held power tool. For this purpose, an operating state of the hand-held power tool is ascertained based on sensor data of at least one operating variable of the hand-held power tool by executing a state determination module on the sensor data. The hand-held power tool is then controlled taking the ascertained operating state into account. According to various embodiments, the control of the hand-held power tool can be adapted precisely to the current operating state. Control can also take place independently of the user's input. For example, the user input can be adapted to the current operating state so that the hand-held power tool can be controlled in a manner appropriate to the operating state, even if the user input would result in a different control that does not match the operating state.

According to one embodiment, the control of the hand-held power tool comprises:
ascertaining a second target value of the control parameter based on the determined operating state of the hand-held power tool;
ascertaining an output target value of the control parameter based on the first target value and the second target value; and
outputting the output target value to an actuator of the hand-held power tool for controlling the hand-held power tool.

The technical advantage thereby is that the control of the hand-held power tool can be adapted precisely to the current operating state. For this purpose, the hand-held power tool is controlled based on the first and second target values of a control parameter. The first target value is based on a user input from the user of the hand-held power tool. The second target value, on the other hand, is ascertained taking into account the ascertained operating state of the hand-held power tool. Taking into account the first and second target values of the control parameter, an output target value of the control parameter is then ascertained, which is then output to the actuator system of the hand-held power tool to control the hand-held power tool.

By taking the first and second target values into account, both the user input by the user and the current operating state of the hand-held power tool can be taken into account for the control of the hand-held power tool when ascertaining the target output value. This has the advantage that, in particular in cases in which the user input by the user, e.g. by actuating a trigger switch, does not permit optimum control of the hand-held power tool for the current operating state of the hand-held power tool, the control can still be adapted to the current operating state by taking into account the second target value adapted to the current operating state, despite the unsuitable user input.

By taking into account the first target value based on the user input, the control of the hand-held power tool still remains primarily in the hands of the user. Only for certain operating states can the user input be overwritten or better adapted to the current operating state in the form of the output target value, in which the second target value is taken into account. The method therefore enables control of the hand-held power tool adapted to the current operating state of the hand-held power tool, which, in addition to the user inputs, takes into account target values of a control parameter adapted to the current operating states of the hand-held power tool.

For the purposes of the application, a target value is a target value of the control parameter.

According to one embodiment, ascertaining the output target value comprises:

Defining the output target value as a minimum value or a maximum value of the first and second target values and/or

Define the output target value as a product of the first and second target values.

Achieved thereby is the technical advantage that the most precise possible output target value of the control parameter is ascertained by defining the output target value as a minimum value or maximum value between the first and second target values, making it as easy as possible to ascertain the output target value. Depending on the ascertained operating state of the hand-held power tool and depending on the type of control parameter, the selected minimum value or maximum value between the first and second target values of the control parameter can be used to ascertain an output target value of the control parameter that is optimally adapted to the operating state ascertained in each case. This enables the hand-held power tool being controlled as precisely as possible in line with the current operating state.

The control parameter can, e.g., be a rotational speed or torque of a motor of the hand-held power tool. The operating state of the hand-held power tool can, e.g., describe the working progress of the hand-held power tool. If, for example, the hand-held power tool is designed as an electric screwdriver, then an operating state of the hand-held power tool can describe that the screw being screwed is already screwed into the respective workpiece in an interlocking manner.

The target rotational speed or the target torque of the motor entered by the user input of the user by actuating the trigger switch of the hand-held power tool may be too high for such an existing interlocking connection of the screw being screwed inward so that, taking into account the second output target value calculated in each case in the form of a correspondingly lower motor rotational speed or a correspondingly lower motor torque, the output target value of the control parameter describes a reduced rotational speed or torque of the motor of the hand-held power tool compared to the user input. The output target value can therefore be used to achieve control of the hand-held power tool that is optimally adapted to the current operating state.

By defining the output target value as the maximum or minimum value of the first and second target values, the target value best suited to the current operating state can be selected as the output target value. In particular, the target value can be limited in relation to the input parameter to a value range suitable for the current operating state.

By multiplying the first and second target values, the second target value can act as a sensitivity in relation to the first target value. The second target value can therefore be used to increase or decrease the first target value, which is based on the user's input, in relation to the current operating state by a factor in the form of the second target value. The user input and the control of the hand-held power tool by the user based on this can therefore be efficiently adapted to the current operating state.

According to one embodiment, ascertaining the output target value comprises:

Defining the output target value as the first target value if the second target value is less than a predefined threshold value, and defining the output target value as a predefined target value if the second target value is greater than or equal to the predefined threshold value.

The technical advantage thereby is that a more precise output target value can be provided, which is optimally adapted to the current operating state of the hand-held power tool. For this purpose, either the first target value based on the user's input or a predefined target value is used as the output target value, depending on the second target value in relation to a predefined threshold value.

Taking the predefined threshold value into account enables simple and precise adjustment of the output target value to the current operating state. Depending on the type of operating state present, the predefined target value as well as the predefined threshold value of the control parameter can be adapted such that the resulting output target value enables optimum control of the hand-held power tool.

The second value of the control parameter ascertained based on the respective operating state can therefore act as a switching value for the first target value of the user input. Depending on the assessment of the second target value in relation to the predefined threshold value, the system switches between the first target value of the user input and the predefined target value as the output target value.

According to one embodiment, ascertaining the output target value comprises:
defining the output target value as a product of the first target value with a first predefined target value if the second target value is less than a predefined threshold value, and defining the output target value as a product of the first target value with a second predefined target value if the second target value is greater than or equal to the predefined threshold value.

The technical advantage thereby is that a more precise output target value can be provided. Depending on the second target value ascertained in relation to the ascertained operating state to a predefined threshold value, the output target value is defined as a product of the first target value based on the user input with a first predefined target value or a second predefined target value. The first and second predefined target values can be in the form of constant target values.

As in the previous embodiment, the predefined target values as well as the predefined threshold value can each be adapted to the current operating state. The first and second predefined target values in turn serve as sensitivity values which, by multiplying with the first target value, increase or decrease the first target value and adapt it to the current operating state.

The second target value ascertained in relation to the operating state is again used as a switching value by switching between the product of the first target value with the first predefined target value and the product of the first target value with the second predefined target value in relation to the respective predefined threshold value by the second target value. This enables the output target value to be adapted as precisely as possible to the operating state ascertained in each case.

According to one embodiment, the ascertainment of the operating state comprises:
predicting the event timepoint, whereby a transition of the hand-held power tool from one operating state to another operating state takes place at the event timepoint.

Achieved thereby is the technical advantage that, in addition to the actual ascertaining of an existing operating state, the state determination module can additionally or alternatively predict an event timepoint that defines a transition between different operating states of the hand-held power tool. By predicting the event timepoint, the control of the hand-held power tool can therefore be adapted to an imminent transition to another operating state. This enables the hand-held power tool to be controlled as precisely as possible by adapting the control system to events or operating states that have not yet occurred but which the hand-held power tool will only enter in the future.

According to one embodiment, the control parameter comprises one or more of the list: Motor rotational speed, motor current, motor output of a hand-held power tool motor.

As a result, the technical advantage of enabling precise control of the hand-held power tool can be achieved while taking into account the target output values of the control parameter. The motor rotational speed, the motor current, or the motor output of the hand-held power tool motor are reliable control parameters on the basis of which the hand-held power tool can be controlled.

According to one embodiment, the operating variable comprises one or more of the list: Motor current, motor position angle, motor rotational speed, voltage of a voltage source of the hand-held power tool, movements and/or vibrations of the hand-held power tool or in the hand-held power tool.

Achieved thereby is the technical advantage that the operating variable provides a meaningful measured variable for determining the operating state. By measuring the motor current, the motor position angles, the motor rotational speed, an operating voltage of a voltage source of the hand-held power tool, or movements and/or vibration of the hand-held power tool or in the hand-held power tool, meaningful information can be obtained on which an operating state of the hand-held power tool can be ascertained.

For example, in the example hereinabove, measurements of the motor current can be used to detect whether a screw being screwed in has, in an interlocking manner, already been screwed into the workpiece being machined. When an interlocking connection is achieved, changes in the motor current as well as the motor rotational speed or the motor speed can be detected so that the operating state can be precisely ascertained. For example, the movement signals can also be used to detect whether the hand-held power tool, e.g. the screwdriver, has been moved to the next work location and, therefore, whether the previous work phase, i.e. the previous screwdriving process, has been completed. This enables the operating state to be reset at the appropriate time, corresponding to the new work phase, i.e. the new tightening process.

According to one embodiment, the operating state comprises one or more of the list: a load range in which the hand-held power tool is operated, a strength of vibrations in the hand-held power tool and/or on a machined workpiece and/or in the user of the hand-held power tool, a temperature in the hand-held power tool and/or on the workpiece, an operating mode in which the hand-held power tool is operated, a work progress of the hand-held power tool, material of the workpiece, an existence of an interlocking connection between the hand-held power tool and the workpiece.

The technical advantage achieved thereby is that different operating states in which the hand-held power tool may be or into which the hand-held power tool may enter can be taken into account when controlling the hand-held power tool in the form of the second target value of the control parameter. The method according to the disclosure can therefore take into account a wide variety of operating states, making it possible to provide a widely applicable control method.

According to one embodiment, the state ascertaining module comprises a trained artificial intelligence means that is trained to ascertain the operating state of the hand-held power tool based on the sensor data of the operating variable and/or to predict the event timepoint.

The technical advantage thereby is that of providing a state ascertaining module that is as reliable and efficient as possible, which is configured to recognize current operating states or predict future event timepoints.

According to an aspect, a method for generating a training dataset for training an artificial intelligence means for ascertaining an operating state and/or predicting an event timepoint of a hand-held power tool is provided, the method comprising:
providing a plurality of measured values of an operating variable of a hand-held power tool, whereby the measured values are each provided with time stamps;
identifying an event timepoint within the plurality of measured values, whereby the event timepoint defines a timepoint at which the hand-held power tool transitions from a first operating state to a second operating state;
providing the measured values with label values that are suitable for identifying whether a respective measured value is associated with the event timepoint and/or the event time range;
arranging the plurality of labeled measured values in a time series based on the timestamps of the measured values; and
providing a training dataset comprising the time series of labeled measured values of the operating variable.

Achieved thereby is the technical advantage of providing an improved method for generating a training dataset for training an artificial intelligence means to ascertain an operating state and/or predict an event timepoint of a hand-held power tool. Accordingly, an improved training dataset can be provided which is optimally adapted to the training of an artificial intelligence means for ascertaining an operating state or predicting event timepoints in the sense of the method for controlling a hand-held power tool according to the preceding embodiments.

For this purpose, measured values of an operating variable of the hand-held power tool are first provided, whereby the measured values are each provided with time stamps. The measured values can be based on a plurality of measurements of the operating size of the hand-held power tool or a plurality of comparable hand-held power tools. The corresponding measured values can, e.g., be recorded during the operation of the hand-held power tool or during the operation of the plurality of hand-hand-held power tools and provided as a corresponding measurement of measured values for the method for generating the training dataset. The measured values of the operating variable recorded during the operation of the hand-held power tools can, e.g., be transferred to a server architecture provided for this purpose, which is configured to provide the corresponding measurement records for the method for generating the training dataset.

Furthermore, based on the time stamps, which define a timepoint at which the respective measured values were recorded, an event timepoint is identified within the plurality of measured values as the timepoint at which the hand-held power tool changes from a first to a second operating state. Furthermore, the measured values are provided with label values that indicate the respective event timepoint. In addition, the plurality of labeled measured values is arranged in a time series and the time series of the labeled measured values is provided as a corresponding training dataset.

Based on a training dataset generated in this way, in which the labeled measured values of the operating variable are arranged in a corresponding time series with regard to their time stamps, an optimized training of an artificial intelligence means can be performed to ascertain an operating state or to predict an event timepoint. The respective labels of the measured values of the operating variable enable an assessment of whether the hand-held power tool was in a first or second operating state at the timepoint of the respective measured value.

Furthermore, at least one label of the measured value enables the exact determination of an event timepoint at which the transition between the two operating states occurs. Providing the measured values with label values corresponds to the labeling of measured values known from the prior art, in which the corresponding label is associated with each measured value of the operating variable as an identifier.

According to one embodiment, the method furthermore comprises:
ascertaining a rotation angle of a motor of the hand-held power tool for each measured value of the operating variable; and
Calculating a rotation timepoint for each measured value of the operating variable, taking into account a time interval required to complete a full revolution of the motor and the time stamps, whereby the rotation timepoint defines a timepoint at which a complete revolution of the motor is completed for a measured value based on the respective time stamp.

The technical advantage thereby is that of further improving the training dataset. For each measured value of the operating variable, an angle of rotation of the motor of the hand-held power tool that was present at the timepoint the measured value of the operating variable was recorded is ascertained. Furthermore, a rotation timepoint is calculated for each measured value of the operating variable, whereby the rotation timepoint describes a timepoint at which a complete rotation has taken place based on the respective rotation angle of the respective measured value of the operating variable. Due to the presence of both time stamps and rotation angles, all other sensor signals/variables can be related to either the time or the rotation angle. This improves the dataset, as states and events are available and can be evaluated both over time and in the course of the rotation angle progression.

Based on the angle of rotation or timepoint of rotation associated with each measured value, a precise prediction of the event timepoint can be made. By knowing, for each measured value of the operating variable with the corresponding time stamp, the timepoint of rotation at which the motor of the hand-held power tool has completed a further complete revolution, the event timepoint can be precisely predicted for each measured value of the operating variable and the corresponding time stamp in each case, taking into account the number of motor revolutions that must be completed to achieve the transition to the second operating state. This enables optimal training of artificial intelligence means.

According to one embodiment, identifying the event timepoint comprises:
receiving sensor data that depicts the operating state of the hand-held power tool;
ascertaining the event timepoint within a time series of sensor data;
synchronizing the time series of the operating variable with the time series of the sensor data; and
identifying the event timepoint in the time series of the operating variable based on the event timepoint of the time series of the sensor data.

Achieved thereby the technical advantage that a further improvement of the method for generating a training dataset and a further improvement of the correspondingly generated training dataset. For this purpose, sensor data from another sensor is taken into account to identify the operating states or to ascertain the event timepoint. The sensor data represent the hand tool in the respective operating state and are suitable for identifying the event timepoint. For this purpose, the sensor data also comprises time stamps that define the timepoints at which the sensor data was recorded.

The sensor data are arranged in a corresponding time series according to their time stamps and the event timepoint is ascertained within the time series based on the respective time stamps. The time series of the measured values of the operating variable and the time series of the sensor data are then synchronized according to the respective time stamps. Based on the event timepoint within the time series of the sensor data, the event timepoint in the time series of the operating variable is then identified. The additional information from the sensor data enables a more precise ascertaining of the event timepoint within the time series of the measured values of the operating variable. Doing so enables a more precise training dataset.

According to one embodiment, the sensor data are data from an external sensor, in particular a camera sensor.

The technical advantage thereby is further improving the method for generating a training dataset. The sensor data are in this case based on data from an external sensor. The latter can, e.g., be designed as a camera sensor. The camera data from the camera sensor can be used to map the operation of the hand-held power tool during which the measured values of the operating variable were recorded. By mapping the operation of the hand-held power tool, the different operating states can be clearly mapped in the sensor data.

It is then possible to clearly identify the timepoint at which the hand-held power tool switches from the first operating state to the second operating state. The event timepoint can, e.g., describe the timepoint when the interlocking connection between the screw and the workpiece is achieved when the screw is screwed into the workpiece in the example described hereinabove. This timepoint can be clearly identified by the camera data of the camera sensor, which depicts the screwdriving process of the hand-held power tool. This makes it possible to uniquely identify the event timepoint by taking into account the time stamps of the camera data, which identify the timepoint at which the camera data were recorded.

By synchronizing the two time series, the measurement data of the operating variable and the camera data, the timepoint when the interlocking connection between the screw and the workpiece is achieved can be precisely identified in the time series of the measurement data of the operating variable. By labeling the measured values of the operating variable accordingly, in which the respective identified event timepoint is indicated, the artificial intelligence means can be trained based on the measured data of the operating variable to ascertain the various operating states of the hand-held power tool or to predict the event timepoint. This enables a precise training dataset on which optimized training of an artificial intelligence means for ascertaining operating states or predicting event timepoints is possible.

According to a further aspect, a method for training an artificial intelligence means to ascertain an operating state of a hand-held power tool is provided, the method comprising:
providing a training dataset generated according to the method according to the disclosure for generating a training dataset according to one of the preceding embodiments; and
executing artificial intelligence training in order to ascertain an operating state and/or predict an event timepoint of a hand-held power tool based on the training dataset.

The technical advantage achieved thereby is that an improved method for training an artificial intelligence means is provided, which is suitable for training the artificial intelligence means to recognize operating states of a hand-held power tool and to predict event timepoints in which a transition between operating states of the hand-held power tool occurs, according to the method for controlling a hand-held power tool according to the disclosure. By using the training dataset according to the disclosure, the training of the artificial intelligence means is adapted to the use case of the artificial intelligence means in the control of the hand-held power tool according to the method for controlling a hand-held power tool, so that optimal training results can be achieved and optimally trained artificial intelligence means can be obtained.

According to a further aspect, an artificial intelligence means is provided for ascertaining an operating state of a hand-held power tool and/or for predicting an event timepoint according to the method according to one of the preceding embodiments, whereby the artificial intelligence means is trained according to the method for training an artificial intelligence means according to the disclosure.

It is thereby possible to achieve the technical advantage of providing a state determination module which is as reliable and efficient as possible for controlling the hand-held power tool in accordance with the method according to the disclosure for controlling a hand-held power tool, which is configured to recognize the respective operating states of the hand-held power tool or to predict event timepoints at which a transition between operating states takes place. By training the artificial intelligence means according to the method for training an artificial intelligence means according to the disclosure, the artificial intelligence means is optimally configured for use in a control system of a hand-held power tool according to the method for controlling a hand-held power tool.

According to one embodiment, the artificial intelligence means is designed as an artificial neural network, in particular as a network with at least one recurrent layer with an internal state memory.

The technical advantage thereby is providing particularly reliable and powerful artificial intelligence means. In particular, the artificial neural network can be designed as a long-short-term memory (LSTM) network. The LSTM network is particularly suitable for recognizing and operating states of the hand-held power tool and for predicting event timepoints in which a transition between different operating states occurs. LSTM networks are known from the prior art for pattern recognition and the prediction of behavior or events based on historical data.

The design of the neural network as an LSTM network (Long Short Term Memory) is suitable as a network layer and can be combined with other network layers in a network.

Provided according to a further aspect is a computing unit, which is configured to perform the method for controlling a hand-held power tool according to one of the preceding embodiments, and/or the method for generating a training dataset according to one of the preceding embodiments, and/or the method for training an artificial intelligence means according to the disclosure, and/or the artificial intelligence means according to the disclosure.

Provided according to a further aspect is a computer program product comprising instructions which, when the program is executed by a data processing unit, prompt the data processing unit to perform the method for controlling a hand-held power tool according to one of the preceding embodiments, and/or the method for generating a training dataset according to one of the preceding embodiments, and/or the method for training an artificial intelligence means according to the disclosure, and/or the artificial intelligence means according to the disclosure.

Provided according to a further aspect is a hand-held power tool comprising a computing unit and at least one sensor for ascertaining sensor data of at least one operating variable of the hand-held power tool, the computing unit being designed to perform a method for controlling the hand-held power tool and the method comprising:
receiving sensor data of at least one operating variable of the hand-held power tool;
receiving an input value for a control parameter of the hand-held power tool based on a user input from a user of the hand-held power tool;
ascertaining a first target value of the control parameter based on the sensor data and the input value;
executing a state determination module on the sensor data and ascertaining of an operating state of the hand-held power tool;
ascertaining a second target value of the control parameter based on the ascertained operating state of the hand-held power tool;
ascertaining an output target value of the control parameter based on the first target value and the second target value; and

Output of the output target value to an actuator of the hand-held power tool for controlling the hand-held power tool.

The technical advantage achieved thereby is that an improved hand-held power tool can be provided which is configured to perform the method for controlling a hand-held power tool with the technical advantages specified hereinabove.

### BRIEF DESCRIPTION OF THE DRAWINGS

Exemplary embodiments of the disclosure are explained with reference to the subsequent drawings. The drawings show:

FIG. 1 a schematic representation of a hand-held power tool according to one embodiment;

FIG. 2 a further schematic representation of a hand-held power tool, in which individual functional sequences of the hand-held power tool are illustrated;

FIGS. 3a and 3b are chronological curves of an operating variable of a hand-held power tool and a rotation angle of a motor of the hand-held power tool;

FIGS. 4a, 4b, and 4c show schematic representations of a hand-held power tool according to one embodiment, with the hand-held power tool shown in various operating states;

FIG. 5 a schematic representation of a drive control of the hand-held power tool according to one embodiment;

FIG. 6 a flow diagram of a method for controlling a hand-held power tool according to one embodiment;

FIG. 7 a further flow diagram of the method for controlling a hand-held power tool according to a further embodiment;

FIG. 8 a further flow diagram of the method for controlling a hand-held power tool according to a further embodiment;

FIG. 9 a schematic representation of an artificial intelligence means that is configured for use in a control system of the hand-held power tool;

FIG. 10 a flowchart of a method for generating a training dataset for training an artificial intelligence means according to one embodiment;

FIG. 11 a further flowchart of a method for generating a training dataset for training an artificial intelligence means according to a further embodiment;

FIG. 12 a flowchart of a method for training an artificial intelligence means; and

FIG. 13 a schematic representation of a computer program product.

### DETAILED DESCRIPTION

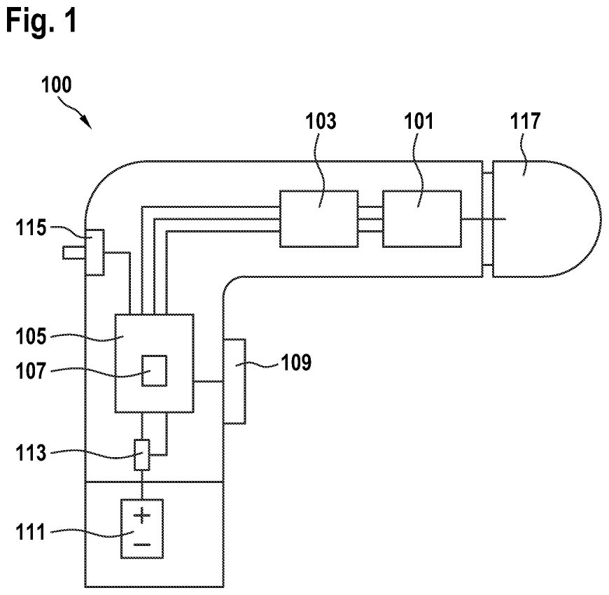

FIG. 1 shows a schematic representation of a hand-held power tool 100 according to one embodiment.

The exemplary hand-held power tool 100 comprises a motor 101 with a motor control means 103. The hand-held power tool 100 further comprises a computing unit 105 on which a state determination module 107 is installed and executable. The computing unit 105 with the state determination module 107 are configured to perform the method according to the disclosure for controlling a hand-held power tool 100. The hand-held power tool 100 further comprises a voltage source 111 and a current measuring device 113. The hand-held power tool 100 further comprises a trigger switch 109, by means of which the hand-held power tool 100 can be controlled by a user. In addition, the hand-held power tool 100 comprises a setting device 115 with which various operating modes of the hand-held power tool 100 can be set. Finally, the hand-held power tool 100 comprises a tool 117, by means of which corresponding operations can be performed by operating the hand-held power tool 100.

The hand-held power tool 100 can, e.g., be designed as a screwdriver or a battery-operated screwdriver. For this purpose, the tool 117 can be designed in particular as a holder for replaceable screwdriver blades.

In particular, the motor control unit 103 shown can comprise an associated power section of the motor control unit. The motor 101 can also include a corresponding transmission, which is not explicitly shown in FIG. 1.

The motor 101 can, e.g., be designed as a mechanical or electrically commutated DC motor. The corresponding transmission can be designed as a planetary transmission.

According to the disclosure, the power section of the motor controller 103 can convert a control signal into the voltage or current curves required for the motor 101, e.g. via PWM pulse width modulation. For this purpose, the control signals can first be converted into corresponding digital signals, whereupon the correspondingly converted signal can be transmitted via a suitable data bus, e.g. I2C or SPI. In the case of an electrically commutated DC motor, a corresponding rotating field can be generated, which can be synchronized with the rotation of the rotor. The motor controller can implement voltage-controlled or speed-controlled regulation. With voltage-controlled regulation, the motor speed is reduced as the load (torque) increases and the operating current rises. Information on the motor speed or angle of rotation can be derived inherently in the system based on the phase changes. Additionally or alternatively, a continuous rotation angle sensor (not shown in FIG. 1) can be used to detect the rotor position. Such a rotor position signal can be transmitted to the computing unit 105 for controlling the hand-held power tool 100. This signal transmission can in turn take place via PWM, I2C, SPI, or analog.

According to one embodiment, instead of the rotation angle sensor, an algorithm is implemented in a control unit that uses the measured motor currents and voltages, which contain signal components that arise from voltages induced back into the rotor, to infer the rotation angle. In this embodiment, the rotation angle sensor can be functionally replaced by the algorithm execution.

The power supply via the voltage source 111 can be provided by a plurality of battery elements, e.g. lithium-ion cells. An appropriate battery management system can prevent overcharging, overcurrent and deep discharging.

According to one embodiment, the trigger switch 109 can be designed as a potentiometer that provides analog control signals to the computing unit 103 for controlling the hand-held power tool 100, which signals correspond to the linear actuation of the trigger switch 109. By actuating the trigger switch 109, corresponding user inputs can be provided to control the hand-held power tool 100.

The current measuring device 113 can determine the battery current of the voltage source 111, which is dominated by the motor current of the motor 101. The control unit usually has a current consumption of less than 200 milliamperes. A low-resistance resistor or a Hall sensor can be used as the measuring element. With the aid of an amplifier circuit and a level adjustment, a current-proportional analog signal can be made available to the computing unit 103 as control of the hand-held power tool 100.

The setting device 115 can be designed as a rotary potentiometer, a rocker switch, or a double switching element. The threshold value required for the automatic function must be implemented so that it can be influenced by the user.

The computing unit 101 can comprise a microcontroller with standard circuitry (voltage regulator, clock source, EMC measures) and communication device (BlueTooth, 4G, WLAN). The microcontroller can comprise an analog-to-digital converter and digital interfaces to generate or acquire the signals of the trigger switch 109, the adjustment device 115, the current measuring device 113, the supply voltage, the motor speed and the control signals of the motor 101. The microcontroller (not explicitly shown in FIG. 1) can execute the state determination module 107 for performing the method according to the disclosure for controlling the hand-held power tool 100.

The hand-held power tool 100 can be designed as a screwdriver, a rotary impact wrench, or a simple battery-driven screwdriver. Alternatively, the hand-held power tool 100 can be designed as an electric drill, an impact drill, a hammer drill, or a drill bit.

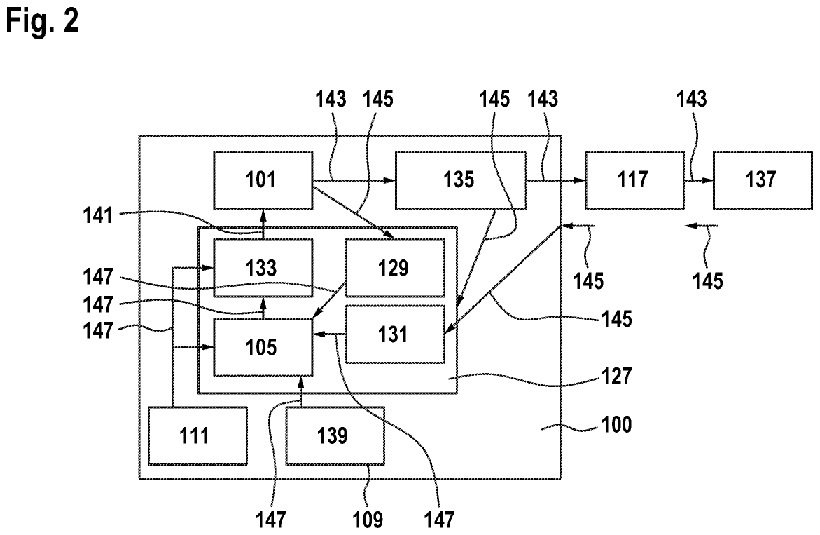

FIG. 2 shows a further schematic representation of a hand-held power tool 100, in which individual functional sequences of the hand-held power tool 100 are illustrated.

FIG. 2 shows a further schematic representation of a design form of the hand-held power tool 100 according to the disclosure. The hand-held power tool 100 comprises the motor 101, the computing unit 105, which is arranged on a circuit board 127, the energy source 109 and the tool 117.

The graphical representation shown illustrates some of the functions of the hand-held power tool 100. Some of the components of the hand-held power tool 100 in FIG. 1 are shown, while other parts or components are not shown in order to keep the illustration shown as simple as possible. However, the hand-held power tool 100 shown can comprise all the components shown in FIG. 1.

In addition to the computing unit 105, which, as previously described hereinabove, can be designed as a microcontroller or can comprise such a microcontroller, and on which the state determination module 107 shown in FIG. 1 is installed according to the disclosure, a speed sensor 129, by means of which a motor speed of the motor 101 can be measured, and a vibration sensor 131, by means of which vibrations of the hand-held power tool 100 can be measured, and an inverter 133 are also installed on the circuit board 127.

Via the trigger switch 109, a user of the hand-held power tool 100 can transmit user inputs 139 to the computing unit 105 by means of an electrical signal transmission 147. The user inputs 139 which, e.g., comprise a trigger level of the trigger switch 109, can be used to control a power of the hand-held power tool 100. Furthermore, the user inputs 139 can define directions of rotation of the motor 101 which, e.g., define a screwdriving or drilling direction, or operating modes of the hand-held power tool 100, which, e.g., describe a screwdriving process with or without an impact function.

Based on the user input 139, the computing unit 105 controls the control of the hand-held power tool 100 and outputs corresponding control signals to the change direction 133 via an electrical signal transmission 147. The inverter 133 outputs a corresponding electrical energy transfer 141 to the motor 101. The motor 101 causes a force transmission 135 to the tool 117 via a corresponding force-torque transmission 143, by means of which the workpiece 137 can be machined.

According to the disclosure, the method for controlling a hand-held power tool 100, which is performed by the computing unit 105, uses measured values of an operating variable, on the basis of which operating states of the hand-held power tool 100 are ascertained. The operating variable can be, e.g., the motor current, a motor output and a speed or torque of the motor 101. In the embodiment shown, the motor rotational speed of the motor 101 is taken into account as the operating variable on the basis of which the operating states of the hand-held power tool 100 are determined by the method according to the disclosure. These are measured by the speed sensor 129 shown, which detects the movement 145 of the motor 101. Furthermore, in the embodiment shown, vibrations/movements 145 of the hand-held power tool 100 or the tool 117 or the workpiece 137 are taken into account as an operating variable. The vibrations/movements are measured by the vibration sensor 131. Corresponding measurement signals are forwarded from the speed sensor 129 and the vibration sensor 131 to the computing unit 105 for further processing.

The vibration sensor 131 can, e.g., be designed as an acceleration sensor.

According to the disclosure, in order to control the hand-held power tool 100, the measured rotational speed or the detected vibrations are analyzed by executing a state determination module 107 and a present operating state of the hand-held power tool 100 is ascertained. Based on the ascertained operating state, the control of the hand-held power tool 100 is adjusted accordingly.

For a more detailed description of the method according to the disclosure for controlling the hand-held power tool 100, reference is made to the description of the drawings hereinafter.

The power transmission 135 of the hand-held power tool 100 can be in the form of a direct drive or via a transmission.

Furthermore, the drive of the hand-held power tool 100, which is only schematically indicated in FIGS. 1 and 2, can comprise various drive options, e.g., an impact mechanism, a hammer mechanism, or a chisel mechanism.

As previously mentioned, the transmission of the power of the motor 101 to the drive of the hand-held power tool 100 can be effected via a transmission. The latter can, e.g., be designed as a manual transmission comprising two, three, or more gears. The transmission can be connected to a slipping clutch, which in turn features a direct connection to the drive. An alternative solution without a slipping clutch, in which the transmission is directly connected to the drive, is also conceivable.

The vibrations or movements measured by the vibration sensor 131 can comprise, e.g., movements of the hand-held power tool 100 triggered by the user of the hand-held power tool 100. Furthermore, the movements or vibrations can be caused by the motor, transmission or drive. Alternatively, the movements or vibrations measured by the vibration sensor 131 can be caused by movements of a bit on a screw head or can result from forces exerted by the screw on the workpiece 137 being machined.

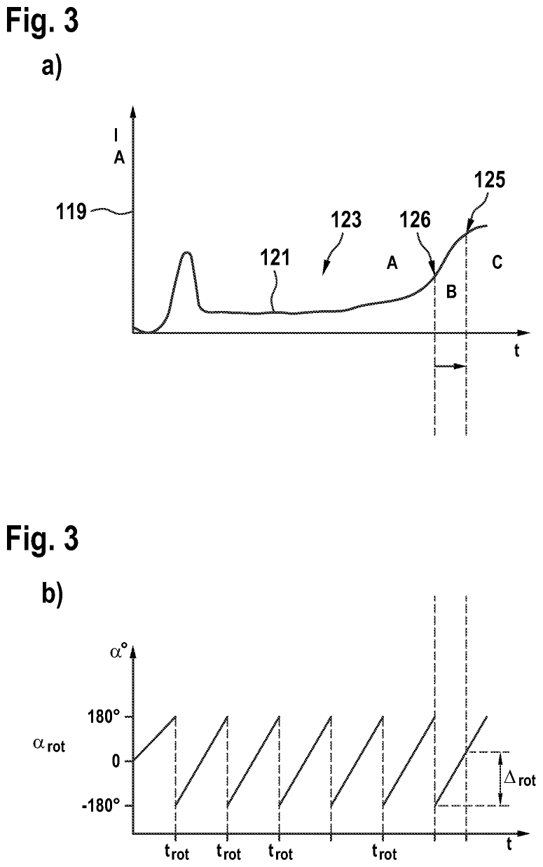

FIGS. 3a and 3b show chronological curves of an operating variable 119 of a hand-held power tool 100 and a rotation angle αᵣₒₜ of a motor 101 of the hand-held power tool 100.

Graph a) shows the progression over time of an operating variable 119 of a hand-held power tool 100. In the embodiment shown, the operating variable 119 describes a motor current of a motor 101 of a hand-held power tool 100. In the embodiment shown, the hand-held power tool 100 is designed as a screwdriver, and the curve shown for the operating variable 119 shows the course of the motor current over time in a screwdriving operation in which a self-tapping screw is screwed into a workpiece 137 made of wood or a comparable material.

The chronological curve of the operating variable 119 describes a time series 123 consisting of a plurality of time-ordered measured values 121 of the motor current. The measured values 121 were recorded during operation of the hand-held power tool 100, i.e. when the screw was screwed into the workpiece, by means of a corresponding current sensor within the hand-held power tool 100.

Graph a) describes a typical curve of the motor current I when screwdriving a self-tapping screw into wood or similar materials. The motor current I represents the torque output by the motor 101 through the torque constant with the unit Newton meter per ampere. The torque resulting from the starting current is used to accelerate the rotor of the electric motor 101 at the beginning of the screwdriving process. This results in the peak of the motor current I that occurs at the beginning of time series 123. After the rotor starts up, the speed is largely constant, which causes the motor current I to run almost horizontally.

This range, in which first the starting peak and then the almost horizontal course of the motor current I is detected, is characterized by the operating state A in Graph a). In this operating state A, more than 90% of the applied torque is converted into actual mechanical work on the screw or workpiece and the screw is screwed into the workpiece accordingly.

In Graph a), two event timepoints 125, 126 are also marked, in which a transition between operating state A, first into an operating state B and then into a further operating state C takes place.

In the range of the event timepoint 126, the motor current I shows a steady increase in operating state A. This is due to the further screwdriving of the screw into the workpiece, for which an ever greater torque is required with increasing screw-in depth, for the generation of which an increasing motor current I is required.

Starting from event timepoint 126, the motor current I increases more steeply compared to the relatively gentle increase in operating state A. This steeper increase in motor current I is caused by the tapered screw head of the self-tapping screw resting on the surface of the workpiece being machined. At the timepoint of event timepoint 126, the conical screw head of the self-tapping screw hits the surface of the workpiece. Operating state B is therefore characterized by the tapered screw head being screwed into the workpiece. Due to the conical shape of the screw head, an increased torque is required to screw the screw head into the workpiece, which is the reason for the steep increase in motor current I.

Event timepoint 125, on the other hand, describes the transition from operating state B, in which the screwdriving of the conical screw head into the workpiece is described, to operating state C, in which the screw head is completely screwed into the workpiece. Event timepoint 125 describes the point at which the screw head is flush with the surface of the workpiece. This timepoint is also known as the flush point. The timepoint characterized by event timepoint 126, at which contact of the conical screw head with the surface of the workpiece occurs, is also referred to as the pre-flush point.

In the design shown, a flattening curve of the motor current I is shown in operating state C. This can be achieved by shearing off the head or by damaging the material of the workpiece when the screw is tightened further beyond the flush point.

Graph b) shows the progression of a rotation angle αᵣₒₜ over time. The chronological curve shows the signal of a rotary encoder as an example. In the example shown, the sensor features a uniqueness range of 360°. This is not necessary, and smaller uniqueness ranges are also sufficient. As a rule, the uniqueness range of the sensor can be coupled to the speed of the motor 101. Absolute rotation angle information over the entire screwdriving process from the start (actuation of the trigger switch 109 by the user) to the desired switch-off can be obtained from the rotation angle sensor signal using phase unwrapping. For this purpose, the knowledge of the continuous rotation of the motor 101 can be used to recognize that the change from plus 180° to, e.g., minus 179° actually corresponds to a rotation angle of plus 181°.

In Graph b), rotation timepoints are also indicated as tᵣₒₜ. At the rotation timepoints tᵣₒₜ, the motor 101 rotates completely. The knowledge regarding the rotation timepoints tᵣₒₜ or the rotation angle αᵣₒₜ of the motor 101 can be used in the following to predict the event timepoints 125, 126. When the event timepoint 126 described hereinabove is reached, at which the conical screw head comes into contact with the surface of the workpiece, the event timepoint 125 at which the screw is flush with the surface of the workpiece can be predicted by knowing the angle of rotation. Graph b) also shows a rotation angle difference Δᵣₒₜ as a difference between the rotation angles αred at the event timepoints 125, 126.

The situation shown in FIGS. 3a and 3b is only intended to illustrate one possible application of the method according to the disclosure. Other applications in which the hand-held power tool 100 is not designed as a screwdriver but, e.g., as a drill or chisel or jigsaw, are also intended to be covered by the disclosure. More or fewer and differently configured operating states (A, B, C) can also be taken into account than described in this example.

For example, the hand-held power tool 100 can be designed as a screwdriver. Possible operating states A, B, C can describe a screwdriving depth of a screw to be screwed in, screwdriving in a certain screwdriving mode (impact mode, inward/outward screwdriving), a working efficiency, a defined torque, a choice of the screw used, or a kickback at high torques.

The hand-held power tool 100 can also be designed as a drill. The operating states A, B, C can describe a drilling mode (percussion drilling etc.), an alignment of the hand-held power tool 100 to a surface of a workpiece to be machined, a type of insert tool (metal, wood, stone drill), a drilling depth, an alignment of the hand-held power tool 100 relative to a predetermined drilling point, drilling into cables or pipes, a drill hole being knocked out, the occurrence of drilling dust or a kickback when the hand-held power tool 100 is suddenly tightened.

Furthermore, the hand-held power tool 100 can be designed as a percussion drill or a hammer drill. The operating states A, B, C can describe an operating mode, a work progress, a risk of damage, vibrations and noise or a lack of contact pressure.

Furthermore, the hand-held power tool 100 can be designed as a chisel. Possible operating states A, B, C can describe an incorrect insert tool, an effective position of the hand-held power tool 100 or a work progress.

Furthermore, regardless of the design of the hand-held power tool 100, possible operating states A, B, C can comprise aspects of work safety/comfort, e.g., vibration/noise development, vibration monitoring, torque control with regard to maximum torques, simple control of the hand-held power tool 100, correct clamping of a tool in the hand-held power tool 100 or recognition of situations such as falling from a ladder, drilling into cables or pipes.

By appropriately training an artificial intelligence means of the state determination module 107, the operating states A, B, C explained hereinabove or similar operating states that may occur during operation of a hand-held power tool 100 can be ascertained based on measured values 121 of an operating variable 119 during operation of the hand-held power tool 100.

The operating variable 119 can, e.g., comprise the motor current I or a motor position angle, a motor rotational speed, a voltage of a voltage source, movements and/or vibrations within the hand-held power tool (100), or similar measurable parameters of the hand-held power tool 100.

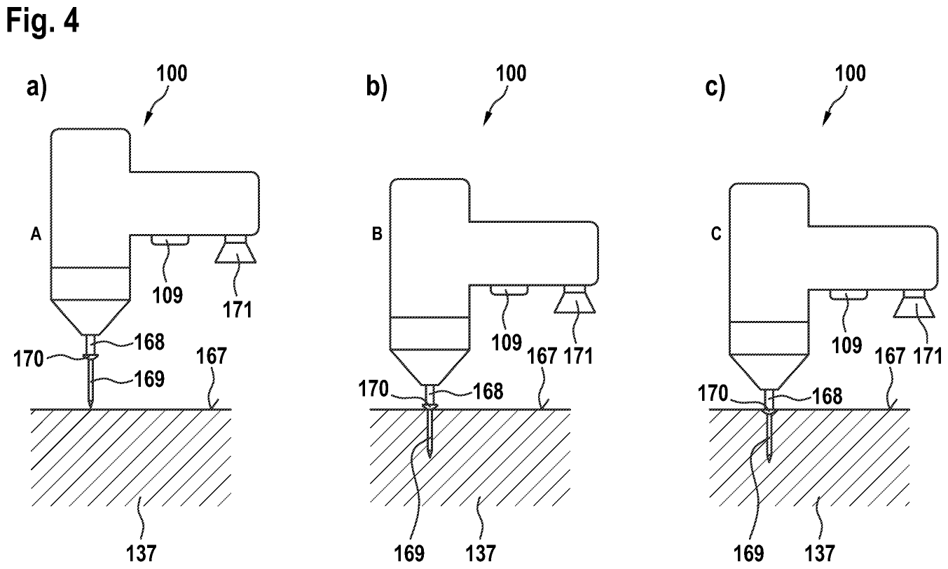

FIGS. 4a, 4b, and 4c shows a schematic representation of a hand-held power tool 100 according to one embodiment, whereby the hand-held power tool 100 is shown in various operating states A, B, C.

FIGS. 4a, 4b, and 4c describes, in the form of graphs, the operating states A, B, C of the hand-held power tool 100 described in FIGS. 3a and 3b. The hand-held power tool 100 is again designed as a screwdriver and the operating states A, B, C describe the screwdriving process in which a screw 169 is screwed into a workpiece 137. The screw 169 can be a self-tapping screw, e.g., and the workpiece 137 can be made of wood. The hand-held power tool 100 also comprises a screwdriver bit 168 for this purpose.

Graph a) shows the operating state A, in which the screw 169 is screwed into the workpiece 137.

Graph b) describes the operating state B, which is characterized by the fact that the conical screw head 170 is adjacent to the surface 167 of the workpiece 137 and is screwed into the workpiece 137 in the further course.

Graph c) describes the operating state C, which is characterized by the screw 169 being flush with the surface 167 of the workpiece 137, whereby the flush point has been reached.

As described hereinabove, FIG. 3a shows the variation over time of the motor current of the motor 101 of the hand-held power tool 100 in the various operating states A, B, C during the screwdriving of the screw 169 into the workpiece 137.

In operating state A, in which the screw 169 is screwed evenly into the workpiece 137, the motor current I shows a largely horizontal curve, which has a slight gradient with increasing screw-in depth.

The operating state B, which is characterized by the conical screw head 170 adjoining the surface 167 of the workpiece 137 and the screwdriving of the screw head 170 into the workpiece 137, the motor current I shows a steep increase, which is due to the increased torque required to screw the conical screw head 170 into the workpiece 137.

In contrast, operating state C, which is characterized by the screw head 170 closing with the surface 167, shows a flattening curve of the motor current I in Graph 3, which may be due to the destruction of the screw or the destruction of the workpiece 137.

In FIG. 4, the hand-held power tool 100 also comprises an external sensor 171. In the embodiment shown, the external sensor 171 is designed as a camera sensor and enables the recording of camera data by means of which the screwdriving process of screwdriving the screw 169 into the workpiece 137 can be mapped. The corresponding camera data can be used for training the state determination module 107 or an artificial intelligence means 149 of the state determination module 107, as will be described in more detail in the following drawings.

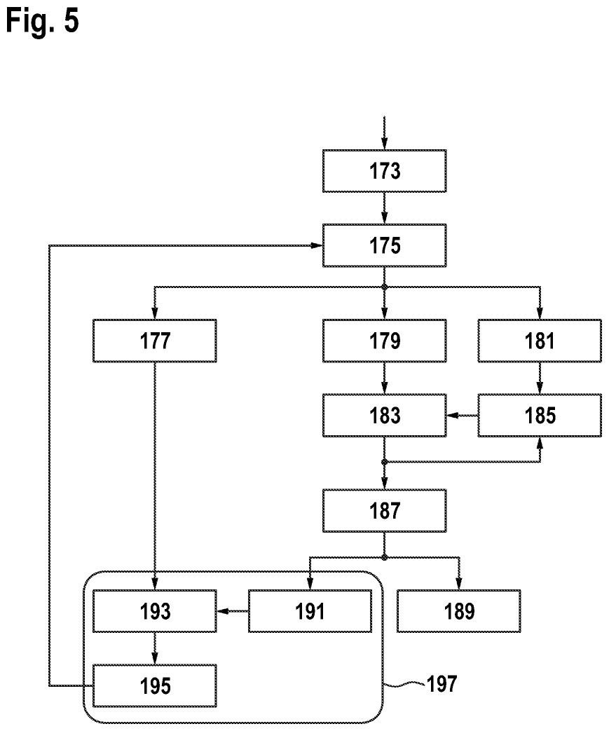

FIG. 5 shows a schematic representation of a drive control 197 of the hand-held power tool 100 according to one embodiment.

FIG. 5 shows a control chain of the hand-held power tool 100.

According to the disclosure, the control chain comprises an inner control loop 193 and an outer control loop 191. The inner control loop 193 is used to control the drive of the hand-held power tool 100 based on the user's input 173.

To control the drive of the hand-held power tool 100 based on the user input 173 of the user by exclusively the inner control loop 193, user input 173 is first provided by the user. This can be done, e.g., by actuating the trigger switch 109. This can be used to define initial target values for a control parameter of the hand-held power tool 100 by the user's input. The control parameter can, e.g., comprise a motor rotational speed, a motor output, or a torque defined via the motor rotational speed. Alternatively, the control parameter can comprise a direction of rotation, e.g. when screwdriving a screw in or out, or an operating mode, e.g. the impact mode or hammer mode. The user input 173 in this case describes the values of the control parameter.

Sensor measurements 175 of an operating variable 119 are used to record actual values of the control parameter, which describe an actual state of the actuators 195 of a drive control 197 of the hand-held power tool 100.

The sensor measurements 175 of the operating variable 119 can comprise measurements of the motor current, the motor rotational speed, the motor output, vibrations of the motor or the hand-held power tool 100, or other meaningful operating variables, by means of which an operating state A, B, C can be determined.

The first target values of the user inputs 173 and the actual values of the sensor measurements 175 of the control parameter are transmitted to the inner control loop 193 by performing digital signal preprocessing 177.

The internal control loop 193 outputs corresponding control signals to the actuator system 195 for controlling the hand-held power tool 100.

The outer control loop 191 is then used to take into account an operating state A, B, C in which the hand-held power tool 100 is located during operation when controlling the hand-held power tool 100.

For this purpose, the first target values of the control parameter of the user input 173 and, in particular, the actual values of the sensor measurements 175 of the control parameter are subjected to a model inference 183 after digital signal preprocessing 197. In the model inference 183, the previously described execution of the state determination module 107 takes effect. The state determination module 107 is in this case configured to recognize an operating state A, B, C, in which the hand-held power tool 100 is located, based on the sensor measurements 175 or the corresponding sensor data of the control parameter. Alternatively or additionally, the state determination module 107 can be configured to predict, based on the sensor data of the sensor measurements 175 of the operating variable 119, an event timepoint 125, 126 at which a transition between different operating states A, B, C of the hand-held power tool 100 takes place.

The state determination module 107 executed in the model inference 183 can in this case be designed as an appropriately trained artificial intelligence means that is trained to ascertain operating states A, B, C or to predict event timepoints 125, 126 based on measured values of an operating variable 119.

The information ascertained by the state determination module 107 in the form of the model inference 183 with regard to the present operating states A, B, C or predicted event timepoints 125, 126 is provided to the external control loop 191 after post-processing 187.

The outer control loop 191 is then configured to define corresponding second target values for the control parameter based on the information of the model inference 183 with respect to the present operating states A, B, C or the predicted event timepoints 125, 126. The second target values for the control parameter defined by the external control loop 191 are matched to the respective operating state A, B, C or the corresponding predicted event timepoints 125, 126. Taking into account the second target value of the control parameter generated by the external control loop 191, the control of the hand-held power tool 100 can be optimally adapted to the respective present operating state A, B, C or the corresponding predicted event timepoints 125, 126.

The second target value for the control parameter generated by the control loop 191 is then provided to the inner control loop 193.

According to the disclosure, the inner control loop 193 is then configured to calculate an output target value for the control parameter, taking into account the first target value for the control parameter provided by the user in the user input 173 and the further second target value for the control parameter provided by the outer control loop 191, taking into account the present operating state A, B, C or the predicted event timepoint 125, 126, and to control the actuators 195 of the hand-held power tool 100 based on the output target value.

The output target value can in this case be calculated by the inner control loop 193, e.g., as a product of the first target value of the user input 173 and the second target value of the outer control loop 191. Via the product of the and first and second target values, the first target value of the user input 173 can therefore be sensitized by the second target value of the outer control loop 191, which was ascertained in relation to the present operating state A, B, C or the predicted event timepoint 125, 126, i.e., adapted to the respective operating state A, B, C or expected event timepoint 125, 126. Alternatively, the output target value can be defined as a minimum or maximum value of the first and second target values. As a result, the output target can be defined as the value of the first and second target values that best matches the operating state A, B, C ascertained in each case.

Alternatively, the output target value can be defined by the first target value of the user input 173 if the second target value of the outer control loop 191 is less than a predefined threshold value, and can be defined as a predefined target value if the second target value is greater than or equal to the predefined threshold value. The predefined target value can be provided as a constant value of the control parameter which was, e.g., adapted to the respective operating state A, B, C or preceding event timepoint 125, 126 when the hand-held power tool 100 was preset. The predefined threshold value can, e.g., be empirically adapted to the respective operating states A, B, C and possible second target values by means of corresponding measurements.

Alternatively, the output target value can be defined as a product of the first target value of the user input 173 with a first predefined target value if the second target value of the outer control loop 191 is less than a predefined threshold value, and can be defined as a product of the first target value of the user input 173 and a second predefined target value if the second target value of the outer control loop 191 is greater than or equal to the predefined threshold value. Depending on the second target value ascertained by the external control loop 191, the first target value of the user input 173 in the form of the first and second predefined target values, which can each be defined as constant values of the control parameter and adapted to the respective present operating states or expected event timepoints, can therefore be sensitized or adapted to the respective present operating state A, B, C or expected event timepoint 125, 126. The first and second predefined target values and predefined threshold values can in turn be determined empirically for possible operating states A, B, C.

In the form of the output target value ascertained by the inner control loop 193, the hand-held power tool 100 can therefore be controlled taking into account the user input 173 made by the user of the hand-held power tool 100 and the corresponding first target value of the control parameter and taking into account the second target value of the control parameter ascertained in relation to the present operating state A, B, C or the expected event timepoint 125, 126.

In the embodiment in FIGS. 3a, 3b, 4a, 4b, and 4c, in which the hand-held power tool 100 is designed as a screwdriver, and in which a screwdriving case is described in which a self-tapping screw 169 is screwed into a wooden workpiece 137, and in which the various operating states A, B, C describe the screwdriving of the screw 169 into the workpiece 137 in operating state A, the screwdriving of the tapered screw head 170 into the workpiece 137 in operating state B and the flat closure of the screw head 170 with the surface 167 of the workpiece 137 in operating state C, the control parameter can, e.g., be a rotational speed of the motor 101 of the hand-held power tool 100.

The user input 173 can, e.g., comprise signals from the trigger switch 109 actuated by the user, by means of which the respective first target value of the motor rotational speed is defined.

The operating variable 119 ascertained in the sensor measurements 175 can, e.g., be provided by the motor current I of the motor 101 of the hand-held power tool 100.

The state determination module 107, which is applied to the measured values of the motor current I according to the model reference 183, can be configured accordingly to ascertain the various operating states A, B, C based on the motor current I, as shown in FIG. 3a. Furthermore, the state determination module 107 can be configured to predict the respective event timepoints 125, 126 based on the measured values 121.

In the following, the processes described hereinabove and, in particular, the ascertainment of the second target value by the outer control loop 191 and the ascertainment of the output target value by the inner control loop 193 are described for an application in which, according to the embodiments in FIGS. 3a, 3b, 4a, 4b, and 4c, the hand-held power tool 100 is designed as a screwdriver and a screw 169 is screwed into a workpiece 137 thereby.

The user input 173 based on the actuation of the trigger switch 109 can, e.g., define a correspondingly high value of the motor rotational speed as the first target value. Based on the sensor measurements 175 of the motor current, however, the state determination module 107 ascertains that the hand-held power tool 100 is already in the operating state C in Graph 3, in which the flush point has already been reached and a closure of the screw head 170 with the surface 167 of the workpiece 137 has been achieved. Based on this, the outer control loop 191 calculates a substantially lower value for the motor rotational speed as a second target value in order to prevent damage to the screw or the workpiece 137, which would be feared at the high motor rotational speed of the user input 173. By ascertaining the output target value by the inner control loop 193, the obviously too high target value for the motor rotational speed of the user input 173 can therefore be down-regulated by the significantly lower second target value for the motor speed calculated by the outer control loop 191 in order to control the hand-held power tool 100 according to the present operating state C and to optionally switch it off.

For this purpose, the second target value, like the first and second predefined target values, can have a numerical value of 0. The output target value can also be reduced to the numerical value 0, whereby the hand-held power tool 100 can be brought to a standstill.

In the embodiment shown, the information of the model reference 183 can further be displayed in a status display 189.

In addition, the model reference can be subjected to a reset process in which the model versions are reset to an initial value. This can, e.g., be performed during separate screwdriving operations. For example, the state determination module 107 can be reset for each new screwdriving process in which an individual screw is screwed into or unscrewed from a workpiece 137. Alternatively or additionally, a reset can also be performed when the hand-held power tool 100 is switched on or off.

For this purpose, a reset preprocessing 181 is first performed based on the sensor measurements 175 and a reset decision 185 is made on this basis. The reset decision 185 can further be effected by taking into account the results of the model inference 183.

The model inference 183 and post-processing 187 information can be provided in digital or quasi-analog form.

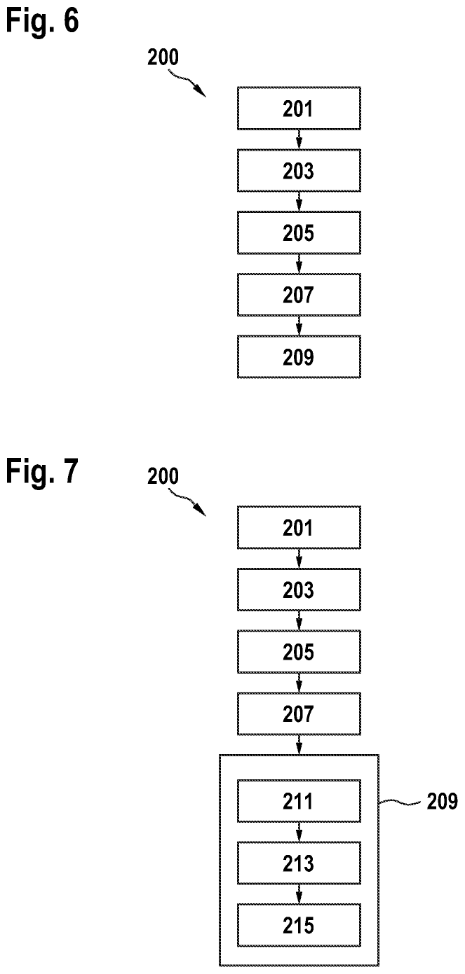

FIG. 6 shows a flowchart of a method 200 for controlling a hand-held power tool 100 according to one embodiment.

To control the hand-held power tool 100, sensor data of at least one operating variable 119 of the hand-held power tool 100 is first received in a first method step 201. The operating variable 119 can comprise, e.g., a motor current, a motor position angle, a motor rotational speed, a voltage of a voltage source, measured values of a movement or vibration of the hand-held power tool 100, or similar parameters by which an operating state A, B, C of the hand-held power tool 100 can be ascertained.

In a further method step 203, an input value based on a user input 173 of a user of the hand-held power tool 100 is received for a control parameter of the hand-held power tool 100. The control parameter can comprise, e.g., a motor rotational speed, a motor current, a motor output, an actuation of the trigger switch 109, an input with respect to an operating mode, e.g. switching on or switching on the impact mode or chisel mode, a direction of rotation of the motor 101, e.g. for screwdriving a screw 169 in or out, or similar control parameters.

In a further method step 205, a first target value of the control parameter is ascertained based on the sensor data of the operating variable 119 and the input value of the user input 173 with respect to the control parameter.

In a further method step 207, a state determination module 107 is executed and applied to the sensor data of the operating variable 119. By executing the state determination module 107, an operating state A, B, C of the hand-held power tool 100 is ascertained. The ascertainment of the operating state can comprise a prediction of an event timepoint 125, 126 in which a transition between two operating states A, B, C takes place. The operating states A, B, C can comprise load ranges in which the hand-held power tool 100 is operated, strengths of vibrations or movements of the hand-held power tool 100 and/or the workpiece 167 being machined, temperatures within the hand-held power tool 100 and/or on the workpiece 167, different operating modes in which the hand-held power tool 100 is operated, work progress of the hand-held power tool 100, materials of the workpiece 137 being machined or, e.g., the previously described existence of an interlocking connection between the hand-held power tool 100 and the machined workpiece 137, in which a screw head 170 of a screw 169 being screwed inward is flush with a surface 167 of the workpiece 137. Alternatively, other and additional operating states of the hand-held power tool 100 are conceivable, which can be detected by analyzing the measurable operating variables 119 of the hand-held power tool 100.

In a further method step 209, based on the first target value of the user input 173 and taking into account the ascertained operating state A, B, C in which the hand-held power tool 100 is located, a control of the hand-held power tool 100 is effected. As previously described hereinabove, the first target value of the control parameter of the user input 173 can be adapted to the current operating state A, B, C in order to achieve a control adapted to the current operating state A, B, C in each case.

The control 209 can comprise, e.g., the adjustment of an motor rotational speed, an motor torque, or another control parameter.

FIG. 7 shows a further flow diagram of the method 200 for controlling a hand-held power tool 100 according to a further embodiment.

The embodiment in FIG. 7 is based on the embodiment in FIG. 6 and the method 100 comprises all the method steps shown there.

In the embodiment shown, a method step 211 is first performed to control 209 the hand-held power tool 100.

In method step 211, a second target value of the control parameter is ascertained based on the ascertained operating state A, B, C or predicted event timepoint 125, 126 of the hand-held power tool 100. As described regarding FIG. 5, the second target value can be ascertained by the external control loop 191. The ascertainment of the second target value can comprise a calculation of the second target value, in which a corresponding second target value is calculated during execution and when the respective present operating state A, B, C is recognized or when the expected event timepoint 125, 126 is predicted. Alternatively, the ascertainment can comprise reading out a corresponding second target value from a look-up table in which suitable second target values are previously stored for various possible operating states A, B, C or predicted event timepoints 125, 126. Alternatively, the state determination module 107 can also be configured to ascertain correspondingly adapted second target values of the control parameter based on the ascertained operating state A, B, C.

In a further method step 213, an output target value of the control parameter is ascertained based on the first target value and the second target value. As previously explained regarding FIG. 5, the ascertainment of the output target value is effected by the inner control loop 193. Ascertaining can in turn comprise calculating a corresponding output target value based on the first and second target values. Alternatively, a corresponding output target value can be read from a previously stored look-up table. Alternatively, the state determination module 107 can again be configured to ascertain the target output value of the control parameter based on the first and second target values.

In a further method step 213, the output target value is output to an actuator 195 of the drive control 197 of the hand-held power tool 100 for controlling the hand-held power tool 100.

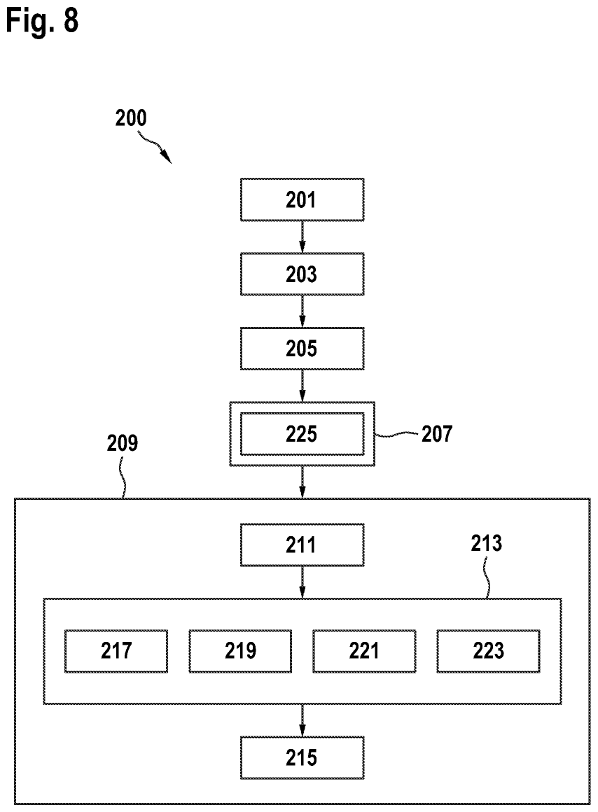

FIG. 8 shows a further flow diagram of the method 200 for controlling a hand-held power tool 100 according to a further embodiment.

The embodiment shown is based on the embodiment in FIG. 7 and comprises all the method steps described there.

In the embodiment shown, ascertaining 207 the operating state A, B, C further comprises predicting 225 an event timepoint 125, 126 at which a transition between different operating states A, B, C occurs.

Furthermore, ascertaining 213 the output target value comprises a method step 217. In the method step 225, the output target value is defined as a minimum value or a maximum value of the first and second target values.

Furthermore, the method step 213 comprises a method step 219. In the method step 219, the output target value is defined as the first target value if the second target value is less than a predefined threshold value. If the second target value is greater than or equal to the predefined threshold value, the output target value is defined as a predefined target value. In a method step 221, the output target value is defined as a product between the first and second target values.

In a method step 223, the output target value is defined as a product between the first target value and a first predefined target value if the second target value is less than a predefined threshold value. If the second target value is greater than or equal to the predefined threshold value, the output target value is defined as a product between the first target value and a second predefined target value.

The predefined target values can be designed and previously stored as constant values of the control parameter. The corresponding threshold values can also be previously stored. The defined target values as well as the predefined threshold values can be optimized for optimized operation of the hand-held power tool 100 for the respective operating states A, B, C or preceding event timepoints 125, 126.

As previously explained regarding FIG. 5, the ascertainment 213 of the output target value in the embodiment shown is effected by the inner control loop 193. The predefined target values as well as the second target value, which is ascertained by the external control loop 191, can assume the numerical value 0. Depending on the control parameter selected, this can cause the hand-held power tool 100 to be switched off.

By taking into account the predefined target values or the second target value in accordance with the described method steps 215 through 221, an adaptation of the first target value of the control parameter, which is based on the user input 173 by the user, can be adapted to the respective present operating state A, B, C or the expected event timepoint 125, 126.

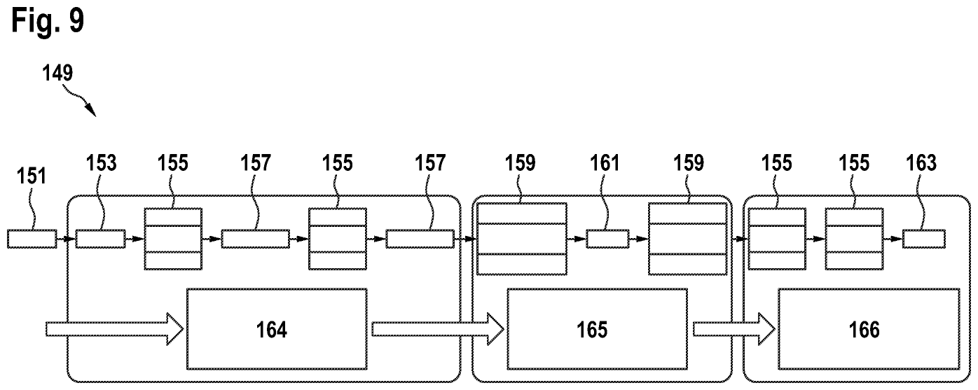

FIG. 9 shows a schematic representation of an artificial intelligence means 149, which is configured for use in a control system of the hand-held power tool 100. The artificial intelligence means 149 is also referred to as an artificial intelligence system.

The state determination module 107 can comprise an appropriately trained artificial intelligence means 149, which is trained to ascertain existing operating states A, B, C or to predict event timepoints 125, 126 based on measured values of the operating variable 119. The state determination module 107 can further be configured to ascertain second target values or output target values.

FIG. 9 shows an embodiment of such an artificial intelligence means 149, which can be used to ascertain operating states A, B, C or to predict event timepoints 125, 126.

In the embodiment shown, the artificial intelligence means 149 is formed as an artificial neural network and in particular as a Long Short Term Memory LSTM network.

In the embodiment shown, the artificial neural network comprises an input layer 153 for receiving input data 151. The input data can comprise the sensor data of the operating variable 119 in an appropriately preprocessed form.

Furthermore, the artificial neural network comprises two dense layers 155 and two pooling layers 157, which are arranged one after the other in alternating form. In addition, the artificial neural network comprises two long-short-term memory layers 159 between which a dropout layer 161 is arranged. Finally, the artificial neural network also comprises two dense layers and an output layer 163.

During data processing, the input layer 153, the first two dense layers 155 and the two pooling layers 157 are first downsampled 164. The two following LSTM layers 159 and the intermediate dropout layer 161 cause feature extraction 165. The last two dense layers 155 and the output layer 163 enable a prediction 166.

In deviation from the embodiment shown, the artificial intelligence means 149 used can also be structured in a different model architecture that is capable of performing a regression or classification based on a time series 123 of measured values 121 of the operating variable 119. On the other hand, a prerequisite for the artificial intelligence model architecture 149 used is that the respective model can be provided in a format that can be executed on a microcontroller of a hand-held power tool 100.

A Tensorflow/Keras model with the architecture shown hereinafter can be used for the embodiment described in this case. After completing the training, the model can first be converted into the Tensorflow-Lite format, which in turn can be translated into C code for the microcontroller using a TVM converter.

The three input channels can be, e.g., the motor current I of the motor 101, the trigger voltage of the trigger switch 109 and the motor revolutions per second.

The architecture used can be structured as follows in Table 1:

TABLE 1

| | | Number of |
|---|---|---|
| Layer (type) | Output form | parameters |
| denseG0_8 (Dense) | (None, None, 8) | 32 |
| pool0_4 | (None, None, 8) | 0 |
| (AveragePooling1D) | | |
| denseG1_16 (Dense) | (None, None, 16) | 114 |
| pool1_4 | (None, None, 16) | 0 |
| (AveragePooling1D) | | |
| 1stm0_32 (LSTM) | (None, None, 32) | 2272 |
| dropout0_0.25 (Dropout) | (None, None, 32) | 0 |
| lstm1_8 (LSTM) | (None, None, 8) | 1312 |
| denseG2_4 (Dense) | (None, None, 4) | 36 |
| dense0_1 (Dense) | (None, None, 1) | 5 |

Absolute number of parameters used: 7,801
Of these, trainable parameters: 7,801
non-trainable parameters: 0

The first dense layer 155 can be formed with a 6×8 kernel and an 8 bias. The second dense layer 155 can be formed with an 8×16 kernel and a 16 bias. The first LSTM layer 159 can be formed with a 16×128 kernel, a 32×128 recurrent kernel and a 128 bias. The second LSTM layer 159 can be formed with a 32×32 kernel, an 8×32 recurrent kernel and a 32 bias. The third dense layer 155 can be formed with an 8×4 kernel and a 4 bias. The fourth dense layer 155 can be formed with a 4×1 kernel and a 1 bias.

The dense layer 155 and the LSTM layer 159 can be formed with a Tan H activation function.

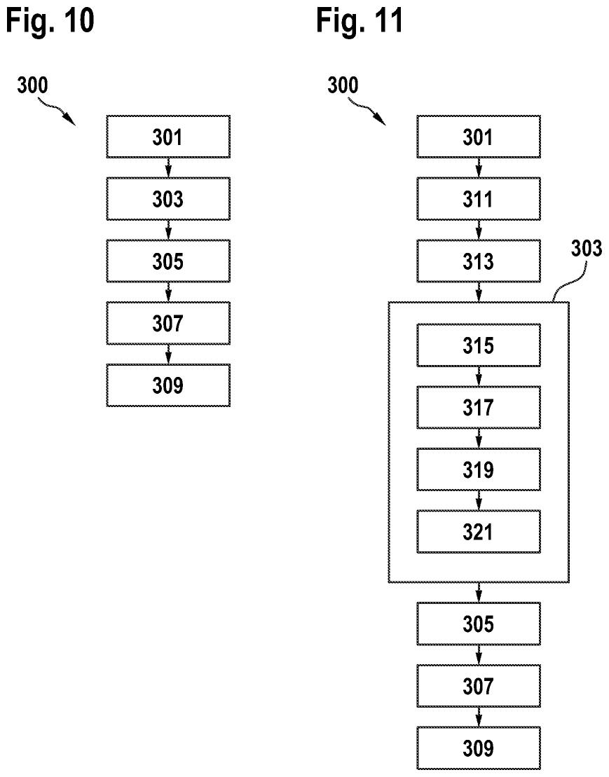

FIG. 10 shows a flowchart of a method 300 for generating a training dataset for training an artificial intelligence means 149 according to one embodiment.

To train the artificial intelligence means 149, a training dataset is first generated in accordance with the disclosure. For this purpose, according to the method 300 according to the disclosure, a plurality of measured values 121 of the operating variable 119 of the hand-held power tool 100 is first provided in a method step 301. The measured values 121 in this case each comprise time stamps that define the timepoints at which the measured values 121 were recorded. The measured values 121 can be recorded during operation of the hand-held power tool 100. Alternatively, the measured values 121 may have been recorded during the operation of a plurality of different hand-held power tools 100 of the same type. The measured values 121 of the operating variable 123 can be recorded by the plurality of different hand-held power tool 100 and transmitted, e.g., to a server architecture provided for generating a training dataset. Said server architecture can process and archive the measurement data in order to generate a corresponding training dataset.

For this purpose, in a further method step 303, an event timepoint 125 is identified within the plurality of measurement data 121 at which an operating state transition between two operating states A, B, C takes place. Event timepoint 125 is identified based on the time stamps of the individual measured values 121.

In a further method step 305, the measured values 121 are provided with label values that are suitable for assigning the respective measured value to an operating state A, B, C or for labeling it with the respective event timepoint 125, 126. The label values can, e.g., be provided by algorithms for labeling training data for artificial intelligence means 149 that are provided for this purpose and known from the prior art. Alternatively, the measured values 121 can be labeled manually by appropriately trained personnel. Alternatively, the measured values, which are automatically labeled using an algorithm, can be checked by appropriately trained personnel to ensure that the labeling is correct and error-free.

In a further method step 307, the labeled measured values 121 of the operating variable 119 are arranged in a time series 123. This is based on the time stamps. The time series 123 describes a temporal arrangement of the labeled measured values 121 according to the time stamps.

After the method step 307 and before a further method step 309, a consolidation of the plurality of existing labels can be performed. This can be done in particular on the basis of statistical criteria. For example, by calculating a median of the event timepoint from multiple manual and automatic sources, a more robust label for the actual event timepoint can be created, resulting in a higher accuracy of the timepoint label.

In the further method step 309, the time series 123 of the labeled measured values 121 of the operating variable 119 is provided as a corresponding training dataset.

FIG. 11 shows a further flowchart of a method 300 for generating a training dataset for training an artificial intelligence means 149 according to a further embodiment.

The embodiment shown is based on the embodiment in FIG. 10 and comprises all the method steps described there.

In the embodiment shown, a rotation angle αᵣₒₜ of the motor 101 of the hand-held power tool 100 is first ascertained in a method step 211 for each measured value 121 of the operating variable 119. For this purpose, the rotation angles αᵣₒₜ of the motor 101 are measured by corresponding rotation angle sensors 129 and associated with these based on the time stamps of the measured values 121. The rotation angles αᵣₒₜ of the motor 101 describe the rotation angle that the motor 101 had at the timepoint the respective measured value 121 of the operating variable 119 was recorded.

In a further method step 313, a rotation timepoint tᵣₒₜ is calculated for each measured value 121 of the operating variable 119, taking into account a time interval required to perform a complete rotation of the motor 101 and taking into account the time stamp of the respective measured value 121. The rotation timepoint tᵣₒₜ describes the timepoint at which the motor 101 has completed a full rotation based on the angle of rotation αᵣₒₜ of the respective measured value 121.

In the embodiment shown, identifying 303 the event timepoint 125, 126 further comprises method step 315. In this method step, sensor data from an external sensor 171 are received. The sensor data of the external sensor 171 represent the operating state A, B, C of the hand-held power tool 100. The external sensor 171 can, e.g., be designed as a camera sensor. The camera data of the camera sensor can be used to map the operating state A, B, C in which the hand-held power tool 100 was at the timepoint the measured values 121 of the operating variable 119 were recorded. As shown in FIGS. 4a, 4b, and 4c, the progress of the process of screwdriving the screw 169 into the workpiece 137 can be mapped or tracked via the camera sensor 171 formed, e.g., on the hand-held power tool 100.

In a further method step 317, the event timepoint 125, 126 is ascertained within a time series of the sensor data of the external sensor 171. The sensor data of the external sensor 171 are arranged in a time series according to their time stamps. By analyzing the image data of the camera sensor, the exact timepoint can be identified at which, e.g., the screw head 170 is flush with the surface 167 of the workpiece 137, as indicated in FIG. 4c. By means of the corresponding time stamps of the recorded image data of the camera sensor 171, the exact timepoint of the event timepoint 125 can therefore be ascertained within the time series of the image data, in which the transition between the operating states B and C shown in FIGS. 4b and 4c has taken place, whereby the flat end between the screw head 170 of the screw 169 and the surface 167 of the workpiece 137 has been reached.

In a further method step 319, the time series 123 of the measured values 121 of the operating variable 119 is synchronized with the time series 123 of the sensor data of the external sensor 171 via the respective time stamps of the measured values 121 or the sensor data of the external sensor 171.

In a further method step 321, the event timepoint 125, 126 in the time series 123 of the measured values 121 of the operating variable 119 is identified based on the event timepoint 125, 126 identified in the time series of the sensor data of the external sensor 171. By synchronizing the time series 123 of the measured values 121 of the operating variable 119, which is, e.g., provided by the motor current I of the motor 101, and the time series of the sensor data of the external sensor 171, each measured value 121 of the operating variable 119 can be associated with a simultaneously recorded image data or sensor data of the external camera sensor 171.

By inspecting or analyzing the image data of the external camera sensor 171, e.g. by appropriately trained personnel, the various operating states A, B, C or the various event timepoints 125, 126 which, e.g., in FIGS. 4a, 4b, and 4c, by the screwdriving of the screw 169 into the workpiece 137, the screwdriving of the screw head 170 into the workpiece 137 and the flat closure of the conical screw head 170 with the surface 167 of the workpiece 137, each measured value 121 can be associated with an operating state of the hand-held power tool 100 as a result of the synchronization of the two time series, namely the time series 123 of the measured values 121 of the operating variable 119 and the time series of the sensor values of the external sensor 171.

By comparing the image data from the external camera sensor 171, in which the various operating states of the hand-held power tool 100 can be easily identified by appropriately trained personnel, and by synchronizing the two time series, the measured values 121 of the operating variable 119 can be precisely associated with the various operating states A, B, C.

By taking into account the sensor data of the external sensor 171, measured values 121 of the operating variable 119 can therefore be precisely labeled and associated with clearly defined operating states via the corresponding labels. This can also be performed in particular for operating variables 119, the course of which does not clearly reveal the various operating states A, B, C or the event timepoints 125, 126 present.

By taking into account the image data of the external camera sensor 171 of the embodiment in FIGS. 4a, 4b, and 4c, the various operating states A, B, C and the present event timepoints 125, 126 can then be precisely determined from the measured values 121 of the time ranges 123 of the course of the motor current I of FIG. 3a, the respective course of the motor current I shown in FIG. 3a does not explicitly represent such various operating states A, B, C or event timepoints 125, 126.

As an alternative to the method steps described, further steps can be performed to generate the training dataset. For example, the recorded measured values 121 of the operating variable 119 or the sensor data of the external sensor 171 can be converted into standard units. The measured values of the rotation angle αᵣₒₜ can also be pre-calculated. In particular, if the measured values of the rotation angles αᵣₒₜ were recorded via Hall sensors, the possibility of an overflow of the Hall sensor data in relation to the Unit 16 data type used can be taken into account.

In particular, recorded rotation angles αᵣₒₜ, for which an overflow can occur due to continuous operation and data type, can be corrected to a continuous value range. This can be advantageously achieved by shifting the angle values to the initial value of zero, whereby the angle of rotation at any timepoint reflects the angular progress compared to the starting point (e.g., of the inward screwdriving process).

Furthermore, the time series 123 of the measured values 121 of the operating variable 119 as well as the time series of the sensor data of the external sensor 171 can be shortened to the time ranges in which the actual operation of the hand-held power tool 100 takes place. According to the embodiment shown in FIGS. 4a, 4b, and 4c, the time series can be limited to the actual screwdriving case in which the screw 169 is actually screwed into the workpiece 137. Measured values that were recorded before the start of the screwdriving process and after the end of the screwdriving process can be removed from the time series. Alternatively, all data before or after a specified timepoint before or after the labeled event timepoint 125, 126 can be removed in order to shorten the time series 123 and reduce the amount of data.

It is also possible to downscale the rate at which the measured values or sensor data are recorded. In addition, the recorded measured values or sensor data can be filtered.

Furthermore, feature extraction can be performed to obtain derived sensor signals, e.g. vector lengths of acceleration, vector lengths of rotation rate from a gyroscope, motor revolutions per second.

In addition, the training dataset can be divided into training data and validation data or test data, as is usual in machine learning. The breakdown can, e.g., be as follows in this case: 70% training data, 20% test data and 10% validation data.

In the course of splitting the data into training, validation and test data, what is referred to as a stratified split can be performed.

However, a different split can be used to demonstrate the generalization of the function across typical operating ranges, in particular by using only certain operating ranges for training and others for validation or testing. In this case, the achievement of the desired generalization is indicated by the fact that the accuracy of the function on the test dataset is only slightly worse than the accuracy of the function in the test dataset with a stratified split. Screw lengths, rotational speed, screw diameter, type and hardness of the wood, and other application parameters can be used as suitable operating parameters.

Normalization parameters can also be calculated. For example, a min-max scaling method (parameters per signal: minimum, maximum) or a standardization method (parameters per signal: mean value and standard deviation) can be used in this case. The parameters can in this case only be calculated using the training dataset. It is important to ensure that the normalization parameters are not distorted depending on the padding selected.

Given that the respective time series 123 can feature a different length depending on the operation of the hand-held power tool 100, e.g. the screwdriving case described in the embodiments in FIGS. 3a, 3b, 4a, 4b, and 4c, since screwdriving cases of different lengths were performed, the training data can be trimmed to a uniform length. This is necessary because the input data for artificial intelligence must have a standardized data format. In this case, it can also be taken into account whether the data padded in this way has a 0 in all signals or whether it is a copy of the first (start padding) or last (end padding) real data.

In the neural network architecture described in FIG. 9, padding is also used to ensure that all time series data can be divided by the total pooling factor Fp, which results from the product of the individual pooling factors in the network, due to the network architecture used, in which effective downsampling is performed within the network by the pooling layers.

As a result, it is ensured that a unique association exists between a label of the output value and each group of Fp samples. In the suitable network architecture shown, the pooling layers result in Fp=16.

The test dataset, on the other hand, can be used unpadded, whereby a result can typically no longer be calculated for the last samples.

Alternatively, augmentation techniques can be used to generate new data that in principle corresponds to real data. This can be used, e.g., to generate new time series of data for operating variable 119.

Finally, normalization can be performed on the basis of the previously calculated normalization parameters (standardization or mini-max scaling).

In addition to the design as a camera sensor, the external sensor 271 can, e.g., also be designed as a microphone. Several external sensors can also be used.

The data acquisition can be recorded on different devices, e.g. a microcontroller and a Raspberry Pi. The data of both the operating variable 119 and the data of the external sensor on the hand-held power tool 100 can be recorded and transmitted to the external server architecture. Due to the different sample rates between the various sensors 171 and the sensors for detecting the operating variable 119, pre-processing of the detected data may be necessary. Metadata in particular can be checked in this case.

The labeling of the measured values 121 can be implemented as an event label in which each measured value 121 is associated with a corresponding timepoint. Alternatively or additionally, state labeling can be performed in which each measured value 121 is associated with a corresponding time range.

Furthermore, the measured values 121 of the operating variable 119 and/or the sensor data of the external sensor 171 can be subjected to a sanity check, in which the accuracy of the respective data is checked.

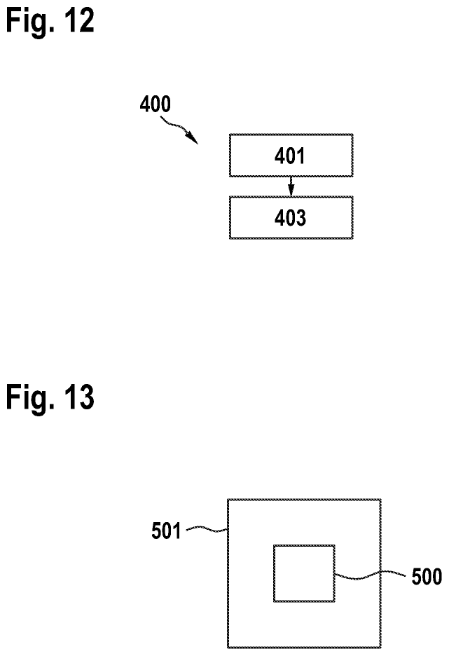

FIG. 12 shows a flowchart of a method 400 for training an artificial intelligence means 149.

For training the artificial intelligence means 149 according to the method 400 according to the disclosure for training an artificial intelligence means 149 for ascertaining an operating state A, B, C of a hand-held power tool 100, a training dataset generated according to the method 300 according to one of the embodiments described hereinabove is first provided in a method step 401.

In method step 403, execution of training the artificial intelligence means 149 to ascertain an operating state A, B, C and/or to predict an event timepoint 125, 126 of a hand-held power tool 100 is performed based on the training dataset. The training can in this case be executed according to the training methods known from the prior art.

Experimentally, a batch size of 16 has proven to be advantageous for training the model architecture of the artificial intelligence means of the embodiment described in FIG. 9. As an optimization algorithm, the Adam algorithm can lead to satisfactory results. A relatively low learning rate of 0.0001 is sufficient for the specific application addressed in this context. As a result, a comparatively high number of training epochs is required. Typically, no upper limit for the number of epochs need be defined in advance, and the training can only be terminated when the validation dataset shows that no further improvement of the model can be achieved over a longer period of time (so-called early stopping). In a training setting that is advantageous for the application addressed in this context, this “longer time” is defined as 300 epochs.

However, since in the course of development it is repeatedly observed that training for the selected learning rate is terminated relatively early (˜ after less than 2000 epochs), and corresponding models clearly perform worse than models that have been trained over more epochs, early stopping is extended to the extent that a minimum number of epochs can be defined. As a result, a minimum of 2000 or 1500 epochs is usually configured. The mean squared error (MSE) is used as the loss function.

Typically, it is advantageous to start the training with part of the time series data before using the entire time series. In particular, the area around a critical point (e.g. a point to be detected) can be used to train the rough behavior of the model. Only in a further step (e.g. after 10%-50% of the total training epochs) is the entire time series used to train the model behavior in the more distant areas.

This approach is particularly advantageous as it reduces the likelihood of achieving a non-optimal training result. For typical applications of screwdrivers and drills, a range of 0.1 s to 10 s before and after the event timepoint can be used, whereby 0.5 s has proven to be particularly suitable for the application addressed herein.

In order to be able to assess the model quality after completion of the training, an automated theoretical evaluation is first performed on the basis of a test dataset. The test dataset has undergone the same pre-processing steps that are also performed on the microcontroller at inference time. These comprise as described hereinabove: Conversion to SI units, calculation of revolutions per second based on the Hall sensor signal, normalization based on the normalization parameters determined on the training dataset.

In the course of the evaluation, these data, which corresponded to the data in live use, are fed into the model in order to analyze the behavior of the model. Given that the activation function of the output neuron is defined as a hyperbolic tangent (tan h), the outputs lie within the value range [−1, 1]. The timepoint within the forecast time series at which a set threshold value is exceeded for the first time is regarded as the trigger timepoint. This can be set to 0, but also closer to −1 or 1 in order to adjust the trigger sensitivity.

The adjustment of the threshold value can in this case either be defined before delivery (advantage: uniform behavior) or kept adaptable in the application, e.g. by means of an adjustment controller. This has the advantage that a more suitable behavior can be selected for different situations. A typical fixed threshold value is between 0 and −1, which enables earlier triggering and compensates for delays caused by processing and machine inertia. A value of −0.85 has proven to be particularly suitable for achieving increased sensitivity with an acceptable probability of false triggering.

Regarding the embodiment described in FIGS. 3a, 3b, 4a, 4b, and 4c, two application-related metrics are primarily used, in which each material-screw combination is also considered separately. In this case, said metrics were:

The average absolute deviation of the trigger timepoint from the desired (i.e., labeled) trigger timepoint, measured in motor revolutions. Furthermore, the relative deviation from the desired trigger timepoint is also considered in the form of a frequency distribution because this shows whether the model tends to trigger too early or too late, or whether the modal value (as desired) is 0.

The number or percentage of screwdriving operations in which the model did not trigger at any timepoint.

The MSE of the loss plays a subordinate role because the exact prediction for the entire time series is less important for real use than the timepoint of the triggering. However, it has been shown that the MSE mostly correlates with the application-related metrics.

Regarding a hand-held power tool 100 designed as a screwdriver, a plurality of combinations of a screw type of the screw 169 and a material type of the respective workpiece 137 can be considered when training the artificial intelligence means 149 of the state determination module 107.

Various parameters can be taken into account that have an influence on the quality of the training of the artificial intelligence means 149 and its subsequent performance in ascertaining the operating states. These include, in particular, the material (e.g., type of wood), the length/diameter/pitch/thread type of the screw, the speed when screwdriving, as well as user influences such as tilting and pressure applied. Given that it is practically impossible to record data for every conceivable combination, and in sufficient quantity, it is advantageous to use selected combinations of different common screw types with a selection of materials of different hardness. The information about the screw/material combination used can be saved in the form of metadata and used during training. In general, it is in this case important to ensure that a sufficient number of recordings (at least 25, preferably more) are made for each combination. It is also advantageous if no combination uses significantly more screwdriving operations than other combinations in order to ultimately obtain a balanced data basis for AI training.

The following is an example of possible screw-timber combinations for the application of “screwdriving into wood”.

Combinations of various application-relevant wood types (e.g., OSB, pine, beech, spruce) and screw types with typical diameters from 2 mm to 6 mm, lengths from 20 mm to 100 mm, head shapes for Torx or Pozidrive and with or without self-tapping threads were used. Records need not be available for every gradation and combination of material properties, but there should be sufficient coverage. A number of 100 or more combinations has proven to be suitable. It is particularly important to avoid unwanted correlations (e.g., between wood type and screw type) in the records that do not correspond to the reality of the application.

As an alternative to the embodiments described hereinabove, the state determination module 107 can also comprise a differently configured artificial intelligence means 149 or a plurality of artificial intelligence means 149. For example, the state determination module 107 can comprise a differently formed artificial neural network, e.g. a temporal convolutional network or a covolutional network. Alternatively, the state determination module 107 can comprise models, e.g. decision tress or ensemble models.

In particular, the state determination module 107 can be designed as a classifier and configured to perform a classification of the individual measured values 121 of the operating variable 119 of the time series 123, to associate the individual measured values 121 of the operating variable 119 to corresponding operating states A, B, C and to ascertain or predict the event timepoints 125, 126 on this basis. The measured values 121 of the operating variable 119 can be processed by the state determination module 107 during operation of the hand-held power tool 100 in accordance with a sliding window and associated with corresponding operating states A, B, C in accordance with the classification. According to a sliding window, the time series 123 of the recorded measured values 121 are therefore analyzed by the state determination module 107, and the operating states A, B, C are thereby ascertained or the event timepoints 125, 126 predicted.

FIG. 13 shows a schematic representation of a computer program product 500 comprising instructions which, when the program is executed by a data processing unit, prompt the data processing unit to perform the method 200 for controlling a hand-held power tool 100 according to one of the preceding embodiments, and/or the method 300 for generating a training dataset according to one of the preceding embodiments, and/or the method 400 for training an artificial intelligence means 149, and/or the artificial intelligence means 149.

In the embodiment shown, the computer program product 500 is stored on a storage medium 501. The storage medium 501 can in this case be any desired storage medium known from the prior art.

What is claimed is:

1. A method for generating a training dataset for training an artificial intelligence system in order to ascertain an operating state and/or to predict an event timepoint of a hand-held power tool, the method comprising:
providing a plurality of measured values of an operating variable of a hand-held power tool, wherein the measured values are each provided with time stamps;
identifying an event timepoint within the plurality of measured values, wherein the event timepoint defines a timepoint at which the hand-held power tool transitions from a first operating state to a second operating state;
providing the measured values of the plurality of measured values with label values which are suitable for identifying whether a respective measured value is associated with the identified event timepoint and/or an event time range;
arranging the plurality of labeled measured values in a time series based on the time stamps of the measured values; and
providing a training dataset comprising the time series of labeled measured values of the operating variable.

2. The method according to claim 1, further comprising:
ascertaining a rotation angle of a motor of the hand-held power tool for each measured value of the operating variable of the plurality of measured values; and
calculating a rotation timepoint for each measured value of the operating variable based on (i) a time interval required to perform a complete revolution of the motor, and (ii) the time stamps,
wherein the rotation timepoint defines a timepoint at which a complete revolution of the motor is completed for a measured value based on the respective time stamp.

3. The method according to claim 1, wherein identifying the event timepoint comprises:
receiving sensor data that depict the operating state of the hand-held power tool;
ascertaining the event timepoint within a time series of the sensor data;
synchronizing the time series of the operating variable with the time series of the sensor data; and
identifying the event timepoint in the time series of the operating variable based on the event timepoint of the time series of the sensor data.

4. The method according to claim 3, wherein the sensor data are data from an external sensor.

5. A method for training an artificial intelligence system in order to ascertain an operating state of a hand-held power tool, the method comprising:
providing a training dataset generated according to the method of claim 1; and
executing training of the artificial intelligence system in order to ascertain the operating state and/or predict the event timepoint of the hand-held power tool based on the training dataset.

6. An artificial intelligence system for ascertaining an operating state of a hand-held power tool and/or for predicting an event timepoint, wherein the artificial intelligence system is trained according to the method of claim 5.

7. The artificial intelligence system according to claim 6, wherein the artificial intelligence system is configured as an artificial neural network comprising at least one recurrent layer having an internal state memory.

8. A computing unit configured to perform the method of claim 1.

9. A computer program product comprising instructions which, when the program is executed by a data processing unit, prompt the data processing unit to perform the method of claim 1.

10. A hand-held power tool comprising:
a computing unit; and
at least one sensor configured to ascertain sensor data of at least one operating variable of the hand-held power tool,
wherein the computing unit is configured to control the hand-held power tool, the computing unit configured to:
receive the sensor data of the at least one operating variable of the hand-held power tool,
receive an input value for a control parameter of the hand-held power tool based on a user input from a user of the hand-held power tool,
ascertain a first target value of the control parameter based on the sensor data and the input value,
execute a state determination module and apply the state determination module to the sensor data and ascertain an operating state of the hand-held power tool,
ascertain a second target value of the control parameter based on the ascertained operating state of the hand-held power tool,
ascertain an output target value of the control parameter based on the first target value and the second target value, and
output the output target value to an actuator of the hand-held power tool for controlling the hand-held power tool.
